(19) United States
(12) Patent Application Publication
(10) Pub. No.: US 2004/0161961 A1
(43) Pub. Date: Aug. 19, 2004

(54) Connector structure

(75) Inventor: Tomomi Endo, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/626,737

(22) Filed: Jul. 25, 2003

(30) Foreign Application Priority Data
Jul. 25, 2002 (JP) P2002-216810

(51) Int. Cl. H01R 13/64

(52) U.S. Cl. 439/374

(57) ABSTRACT

A connector structure includes a connector having a tab terminal, and a housing body having a tab receiving terminal for electrical connecting to the tab terminal. The housing body is to be fitted with the connector. Either a tapered face or a recessed face for preventing interference is formed at a side portion of a front end of the housing body.

### BACKGROUND OF THE INVENTION

This invention relates to a connector structure, and more particularly to a connector structure in which when fitting a pair of female and male connectors together, a gouging engagement is prevented, thereby preventing damage to a connector housing and the deformation of connection terminals.

In a related connector structure shown in FIG. 5, there are provided a pair of female and male connectors 60 and 70, and tab terminals (male terminals) 62 project into the interior of a tubular connector housing 61 of a female connector 60. The tab terminals 62 are electrically connected to a circuit of an equipment such as an electrical equipment.

The male connector 70 includes a connector hood 71, a housing body 72, a front holder 73, a packing 74, and tab receiving terminals (female terminals) 75. The connector hood 71 of a tubular shape has such an inner size (inner diameter) as to fit on the connector housing 61 of the female connector 60.

The housing body 72 receives the tab receiving terminals (female terminals) 75 therein, and is disposed inside the connector hood 71, and can move in a direction of an axis of the connector hood 71 (that, is, in a fitting direction).

The front holder 73 is attached to a front end portion of the housing body 72 through the packing 74, and has terminal holes 76 for respectively guiding the tab terminals 62 of the female connector 60 into the respective tab receiving terminals 75 provided within the housing body 72. The tab receiving terminals 75 are electrically connected to a control circuit for controlling the supply of electric current to the electrical equipment.

As shown in FIG. 6, the front holder 73 includes an end plate portion 77, and a side plate portion 78 extending from the end plate portion 77 and formed over an entire periphery thereof. This front holder is fitted on the housing body 72, with the side plate portion 78 covering the front end portion of the housing body 72. The end plate portion 77 has the terminal holes 76.

In this connector structure, when the male connector 70 is to be fitted into the female connector 60, the housing body 72 of the male connector 70 in its initial condition (in which the front holder 73 projects outwardly from the connector hood 71) is inserted into the connector housing 61 of the female connector 60, with the front holder 73 directed forwardly.

When the fitting of the female and male connectors 60 and 70 proceeds, the connector hood 71 of the male connector 70 fits on the connector housing 61 of the female connector 60, and the tab terminals 62 begin to be inserted respectively into the terminal holes 76 in the front holder 73.

Then, the front holder 73 abuts against a bottom wall 63 of the female connector 60, and the connector hood 71 slides forwardly relative to the housing body 72, so that a completely-fitted condition is detected, and also the tab receiving terminals 75 are electrically connected to the tab terminals 62, respectively.

In the above related connector structure, however, in the case where the female connector 60 is mounted in a narrow space within an engine room of a vehicle or in a narrow space below an instrument panel, the operation for fitting the female and male connectors 60 and 70 together can not be viewed with the eyes, and therefore this fitting operation must be effected only with the sense of the fingers.

In this case, there are occasions when the male connector 70 is fitted into the female connector 60 in an inclined condition as shown in FIG. 7, and this fitting operation involves a so-called gouging engagement in order to bring the terminal holes 76 of the front holder 73 into alignment with the tab terminals 62, respectively.

Therefore, the front holder 73 strikes against the end portion of the connector housing 61 of the female connector 60, or the tab terminals 62 of the female connector 60 are pressed by the side portion of the front end of the front holder 73. As a result, there has been encountered a problem that the connector housing 61 of the female connector 60 is damaged, or the tab terminals 62 are deformed.

### SUMMARY OF THE INVENTION

It is therefore an object of the present invention to provide a connector structure in which when female and male connectors are to be fitted together, this fitting operation can be carried out smoothly, and besides damage to a connector housing and the deformation of connection terminals are prevented.

In order to achieve the above object, according to the present invention, there is provided a connector structure, comprising:

a connector, having a tab terminal; and

a housing body, having a tab receiving terminal for electrical connecting to the tab terminal, the housing body is to be fitted with the connector, wherein either a tapered face or a recessed face for preventing interference is formed at a side portion of a front end of the housing body.

In the above construction, the tapered face or the recessed face for interference prevention purposes is formed at the side portion of the front end of the housing body, and therefore even when the housing body is fitted into the connector in an inclined condition, a corner portion of the front end of the housing body will not interfere with a connector housing of the connector and the tab terminal.

Therefore, when the female and male connectors are fitted together, the housing body is positively prevented from damaging and deforming the connector housing of the connector and the tab terminal.

Preferably, either the tapered face or the recessed face is formed so as to escape an air between the connector and the housing body when the connector is fitted into the housing body.

In the above construction, either the tapered face or the recessed face forms the air escape space at the time of fitting of the housing body into the connector, and therefore during the time when the female and male connectors are fitted together, the air, existing in a gap between the inner periphery of the connector housing of the connector and the outer periphery of the housing body, is allowed to escape.

Therefore, the air, existing around the outer periphery of the housing body, will not become a fitting resistance, so that the operation for fitting the female and male connectors together can be carried out smoothly.

Preferably, The connector structure further comprises the connector hood which covers the housing body , and being movable relative to the housing body. The front end of the housing body is projected forwardly from the connector hood in a non fitted condition between the connector and the housing body. The connector hood slides forwardly on both the connector and the housing body in a completely-fitted condition between the connector and the housing body.

In the above construction, the connector hood serves as a fitting detection member which is movable relative to the housing body, and when detecting a half-fitted condition of the housing body relative to the connector by the position of the fitting detection member, the gouging engagement of the front end of the housing body, projecting forwardly from the fitting detection member, can be positively prevented.

Therefore, when the female and male connectors are fitted together, the housing body, projecting forwardly from the fitting detection member, is positively prevented from damaging and deforming the connector housing of the connector and the tab terminal.

According to the present invention, there is also provided a connector structure, comprising;

a connector, having a tab terminal;

a housing body, having a tab receiving terminal for electrical connecting to the tab terminal, the housing body is to be fitted with the connector; and

a front holder, attached to a front end of the housing body, wherein either a tapered face or a recessed face for preventing interference is formed at a side portion of a front end of the front holder.

In the above construction, either the tapered face or the recessed face is formed at the side portion of the front end of the front holder attached to the front end of the housing body, and therefore when the female and male connectors are fitted together, a corner portion at the front end of the front holder will not interfere with an end portion of the connector housing of the connector and the tab terminal.

The tapered face or the recessed face is formed only by a mold of a predetermined design for molding the front holder which is separate from the housing body, and therefore when it becomes necessary to change the shape of the tapered face or the recessed face, this shape change can be effected only by changing the mold for forming the front holder. Therefore, the productivity can be enhanced without the need for high facility costs.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a longitudinal cross-sectional view of a connector structure according to a first embodiment of the invention, showing female and male connectors in their completely-fitted condition;

FIG. 2 is a perspective view of a front holder of FIG. 1, showing its appearance;

FIG. 3 is a longitudinal cross-sectional view, showing the female and male connectors of FIG. 1 in their half-fitted condition;

FIG. 4 is a perspective view of a front holder used in a connector structure according to a second embodiment of the invention;

FIG. 5 is a longitudinal cross-sectional view of a related connector structure, showing female and male connectors in their completely-fitted condition;

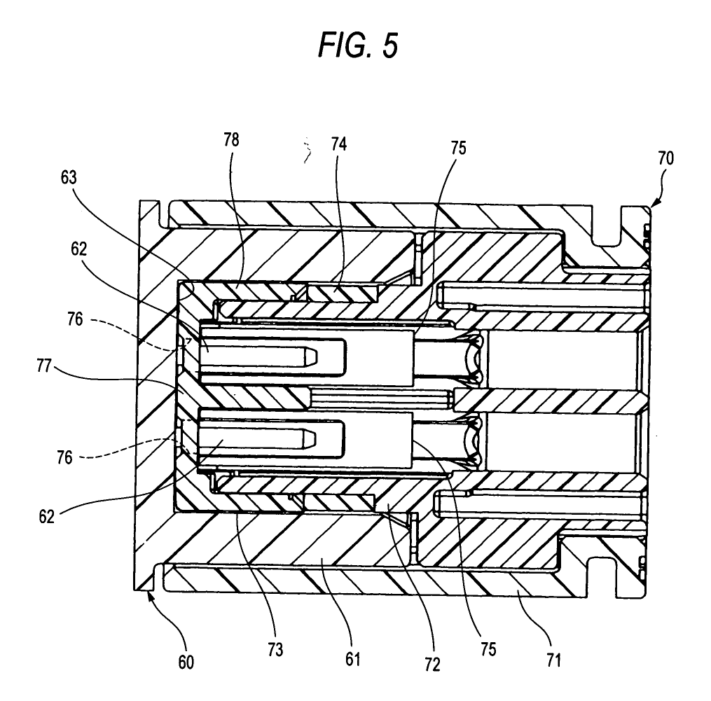

FIG. 6 is a perspective view of a front holder of FIG. 5, showing its appearance; and

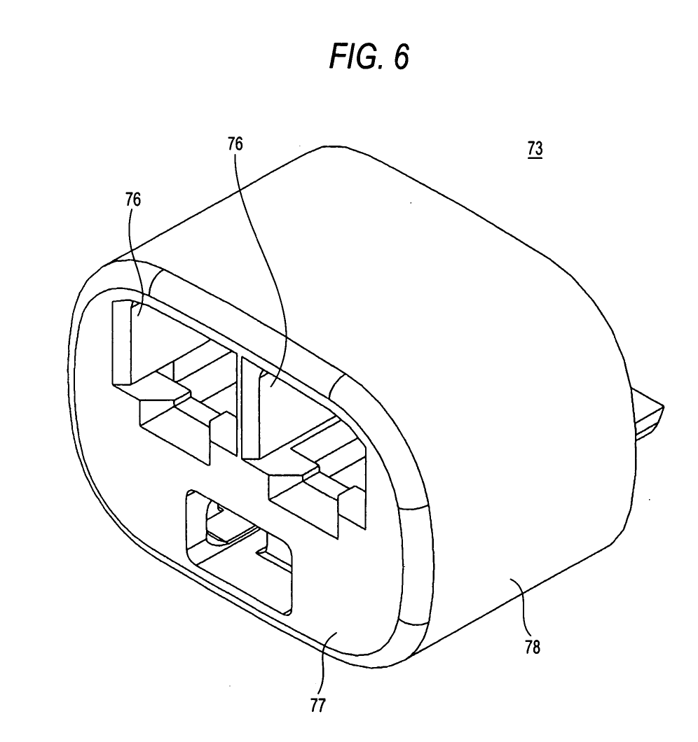

FIG. 7 is a longitudinal cross-sectional view, showing the female and male connectors of FIG. 5 in their half-fitted condition.

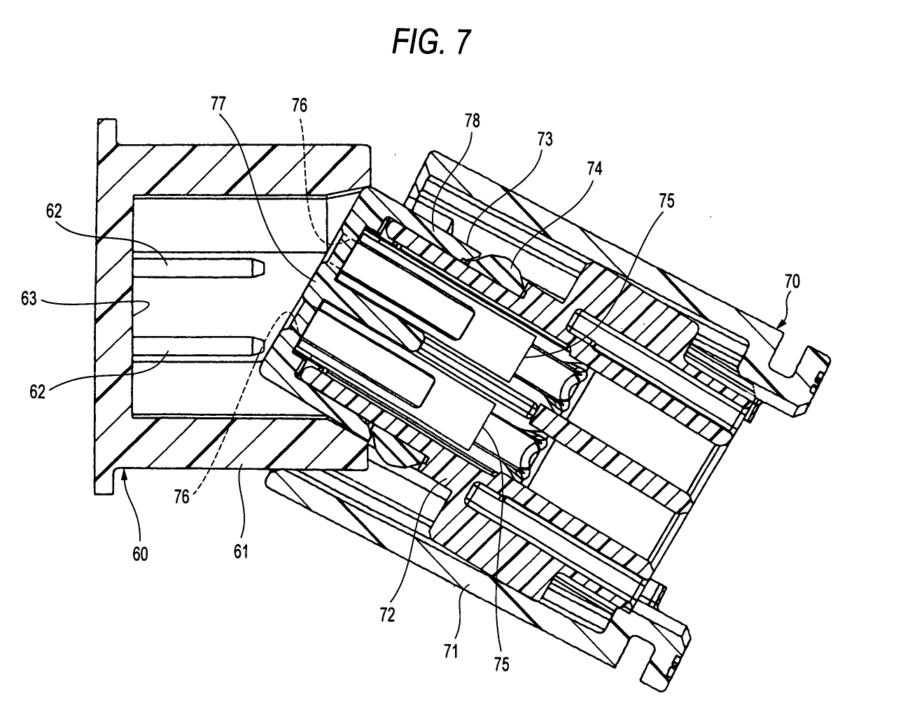

### DETAILED DESCRIPTION OF THE PREFERRED EMBODIMENTS

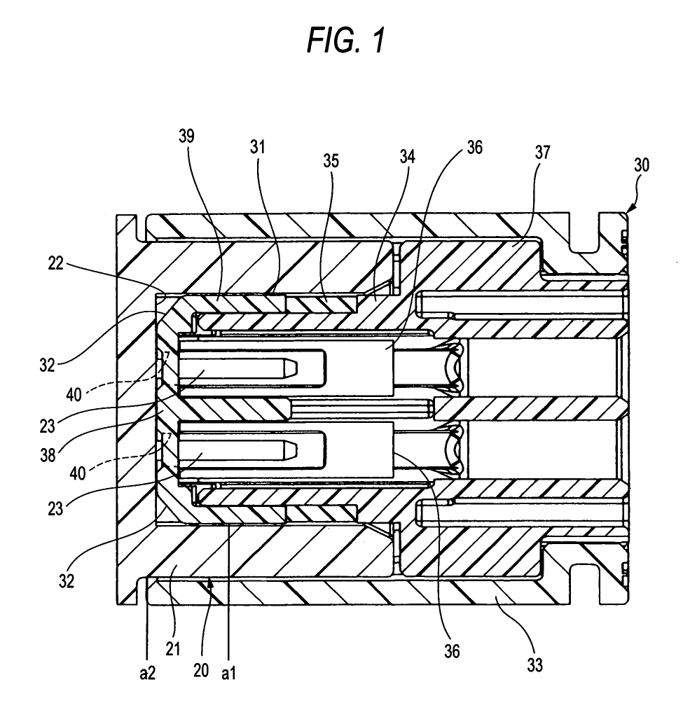

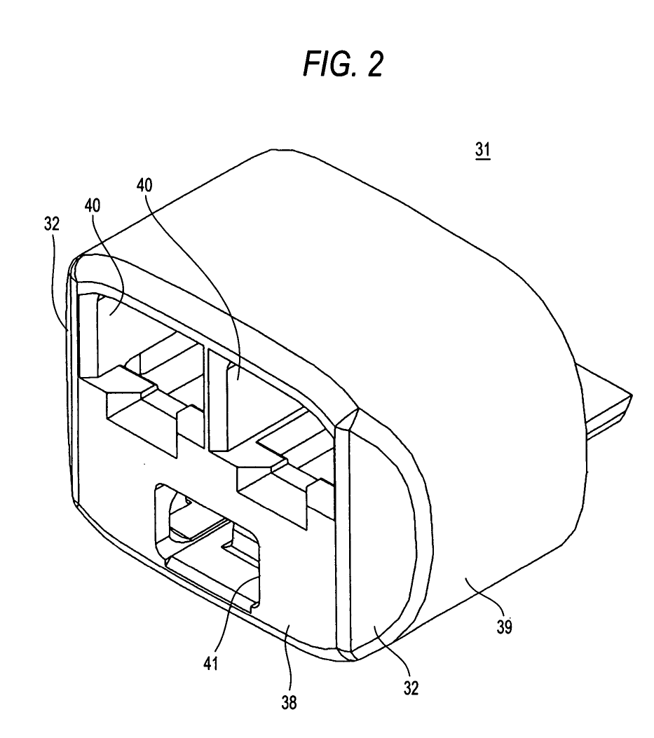

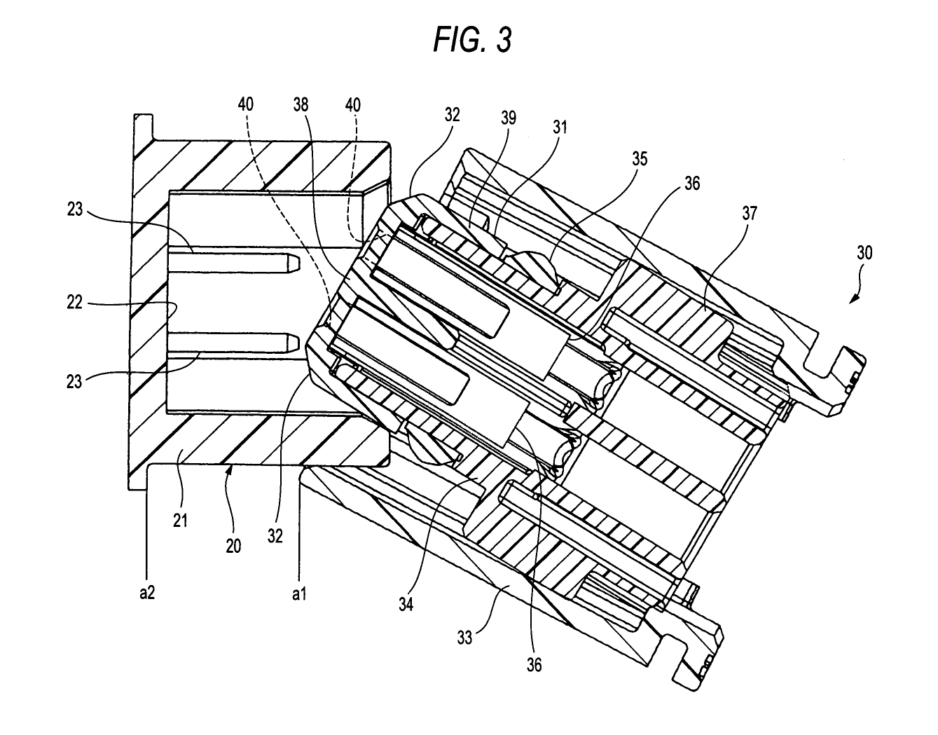

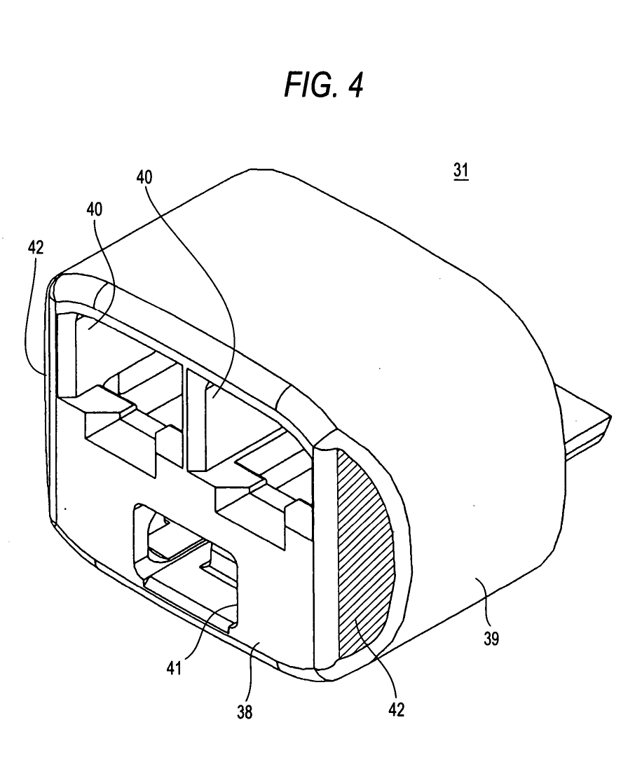

Preferred embodiments of connector structures of the present invention will now be described in detail with reference to FIGS. 1 to 4. FIG. 1 is a longitudinal cross-sectional view of the first embodiment of the connector structure of the invention, showing female and male connectors in their completely-fitted condition, FIG. 2 is a perspective view of a front holder of FIG. 1, showing its appearance, FIG. 3 is a longitudinal cross-sectional view, showing the female and male connectors of FIG. 1 in their half-fitted condition, and FIG. 4 is a perspective view of a front holder used in the second embodiment of the connector structure of the invention.

In the connector structure according to the first embodiment of the invention, the front holder 31, having tapering (slanting) faces 32 for preventing an interference, is attached to a front end portion of a housing body 34 of the male connector 30 for fitting into the female connector 20, as shown in FIG. 1.

The female connector 20 includes a tubular connector housing 21, and a pair of tab terminals (male terminals) 23 project from an inner face of a bottom wall 22 of this connector housing 21. The female connector 20, together with other connectors, is provided at a relay box or the like, and the tab terminals 23 are electrically connected to a circuit of an equipment such as an electrical equipment.

The male connector 30 mainly includes a fitting detection member 33 serving as a connector hood, the housing body 34, tab receiving terminals 36, the front holder 31, and a packing 35.

The housing body 34 has a generally-oval transverse cross-section, and the tab receiving terminals (female terminals) 36 are received respectively in terminal receiving chambers formed in this housing body 34. Engagement projections 37 are formed on an outer peripheral face of the housing body 34, and these engagement projections 37 are engaged with an inner peripheral face of the fitting detection member 33.

The fitting detection member 33 is formed into a tubular shape, and has an inner size (inner diameter) slightly larger than the outer size (outer diameter) of the connector housing 21. This fitting detection member 33 is fitted on the connector housing 21 to provide a fitting space for receiving the connector housing 21. When the completely-fitted condition is achieved, the fitting detection member 33 is slid forwardly from an initial position a1 to a completely-fitting position a2.

Namely, when the fitting detection member 33 is located in the initial position a1, the front holder 31, attached to the front end portion of the housing body 34, projects outwardly from the front end of the fitting detection member 33. When the housing body 34 is completely fitted in the female connector 20, the fitting detection member 33 slides to the completely-fitting position a2 disposed at the front end of the front holder 31.

The tab receiving terminals 36 are electrically connected to a control circuit for controlling the supply of electric current to the electrical equipment.

As shown in FIGS. 1 and 2, the front holder 31 includes an end plate portion 38, and a side plate portion 38 extending from the end plate portion 38 and formed over an entire periphery thereof. The end plate portion 38 has terminal holes 40 for respectively guiding the tab terminals 23 of the female connector 20 into the respective tab receiving terminals 36 provided within the housing body 34.

The front holder 31 is fixed to the housing body 34, with the side plate portion 39 fitted on the front end portion of the housing body 34, and the end plate portion 38 covers the front end of the housing body 34.

In the front holder 31 of this embodiment, the tapered faces 32 for preventing an interference are formed at opposite side ends of the end plate portion 38, respectively. Namely, in order that the opposite side ends of the end plate portion 38 will not interfere with the end portion of the connector housing 21 of the female connector 20 and the tab terminals 23, that is, in order that right-angled corner portions will not be formed in a projected manner at the opposite side ends of the end plate portion 38, respectively, these opposite side ends are formed respectively into chamfered faces of a predetermined tapering angle. The tapered faces 32 provide air escape spaces respectively at the opposite side ends of the end plate portion 38 at the time of fitting of the male connector 30 into the female connector 20, and also the tapered faces 32 function to prevent a gouging engagement at the time of fitting of the front end of the housing body 34 (projecting from the fitting detection member) into the mating connector.

The tapered faces 32 are formed on the front holder 31 which is separate from the housing body 34, and therefore these tapered faces 32 are formed only by a mold of a predetermined design for molding the front holder 31. Therefore, when it becomes necessary to change the shape of the tapered faces 32, this shape change can be effected only by changing the mold for forming the front holder 31, and a mold for forming the housing body 34 does not need to be changed in shape.

Therefore, the productivity can be enhanced without the need for high facility costs.

As shown in FIG. 2, the terminal holes 40 are formed through an upper half portion of the end plate portion 38 of the front holder 31, and a housing engagement portion 41 is formed in a lower half portion of the end plate portion 38. This housing engagement portion 41 is engaged with the housing body 34 when the side plate portion 39 is fitted on the front end portion of the housing body 34.

In the connector structure of this construction, the fitting detection member 33 is first located in the initial position a1 relative to the housing body 34, and in this condition the male connector 30 is fitted into the female connector 20. Namely, the fitting detection member 33 and the housing body 34 are moved relative to the connector housing 21 in parallel relation thereto, and the housing body 34 is fitted into the connector housing 21, and also the front end portion of the fitting detection member 33 is fitted on the connector housing 21.

At this time, the tab terminals 23 of the female connector 20 pass respectively through the terminal holes 40 in the front holder 31, and begin to be inserted respectively into the tab receiving terminals 36 within the housing body 34.

When the fitting of the male connector 30 into the female connector 20 proceeds, the front holder 31 strikes against the bottom wall 22 of the female connector 20, so that the advance of the housing body 34 stops, and also the fitting detection member 33 slides forwardly. Namely, when the housing body 34 reaches the completely-fitting position a2, the fitting detection member 33 slides, and therefore the completely-fitted condition of the female and male connectors 20 and 30 can be detected by this sliding movement. At this time, the tab receiving terminals 36 are electrically connected to the tab terminals 23, respectively.

For example, in the case where the female connector 20 is mounted in a narrow space within an engine room of a vehicle or in a narrow space below an instrument panel within a car room, it is difficult to confirm the position of the female connector 20 with the eyes, and therefore there are occasions when the fitting operation is effected in such a manner that the fitting detection member 33 of the male connector 30 fails to be kept parallel to the connector housing 21.

Namely, the fitting operation is effected, with the fitting detection member 33 inclined relative to the connector housing 21, and the front holder 31, attached to the front end portion of the housing body 34, projects from the fitting detection member 33 since this fitting detection member 33 is located in the initial position a1. Therefore, the front holder 31 enters the connector housing 21 in an inclined condition.

However, the tapered faces 32, formed on the front holder 31, are disposed at the leading end portion in the fitting direction, and a clearance is secured between this tapered face and the tab terminal 23 of the female connector 20, and therefore the front holder 31 will not contact the connector housing 21 and the tab terminals 23.

Therefore, the front holder 31, attached to the front end portion of the housing body 34, is positively prevented from contacting the connector housing 21 of the female connector 20 and the tab terminals 23, thereby positively preventing damage and deformation thereof.

In this condition, as the fitting detection member 33 is fitted on the connector housing 21, the tab terminals 23 of the female connector 20 pass respectively through the terminal holes 40 in the front holder 31, and are inserted respectively into the tab receiving terminals 36 within the housing body 34.

When the fitting of the male connector 30 into the female connector proceeds, the front holder 31 strikes against the bottom wall 22 of the female connector 20, so that the housing body 34 reaches the completely-fitting position a2, and also the fitting detection member 33 slides forwardly, so that the female and male connectors 20 and 30 are completely fitted together.

Namely, even when the male connector 30 is fitted into the female Connector 20 in an inclined condition, the opposite side portions of the front end of the front holder 31 will not interfere with the connector housing 21 and the tab terminals 23 since angular corner portions are not formed respectively at the opposite side portions of the front end of the front holder 31 because of the provision of the tapered faces 32.

Therefore, even when the male connector 30 is rather forcibly fitted into the female connector 20, the connector housing 21 of the female connector 20 will not be damaged, and also the tab terminals 23 will not be deformed, and the tab receiving terminals 36 are positively connected to the tab terminals 23, respectively.

Next, the connector structure according to the second embodiment of the invention will be described. Those members which are similar in construction and operation to those of the above first embodiment will be designated by identical or corresponding reference numerals, and explanation thereof will be simplified or omitted.

In the connector structure of the second embodiment, the front holder 31, having recessed faces 42 for preventing an interference, is attached to a front end portion of a housing body 34 of a male connector 30 for fitting into a female connector 20, as shown in FIG. 4.

The pair of recessed faces 42 are formed at opposite side ends of an end plate portion 38 of the front holder 31, respectively. Namely, in order that the opposite side ends of the end plate portion 38 will not interfere with an end portion of a connector housing 21 of the female connector 20 and tab terminals 23, that is, in order that right-angled corner portions will not be formed in a projected manner at the opposite side ends of the end plate portion 38, Respectively, these opposite side ends are formed respectively into stepped faces of a predetermined shape (see FIG. 1).

As in the first embodiment, the recessed faces 42 provide air escape spaces respectively at the opposite side ends of the end plate portion 38 at the time of fitting of the male connector 30 into the female connector 20, and also the recessed faces 42 function to prevent a gouging engagement at the time of fitting of a front end of a housing body 34 (projecting from a fitting detection member 33) into the mating connector.

Also, the recessed faces 42 are formed on the front holder 31 which is separate from the housing body 34, and therefore when it is necessary to change the shape of the recessed faces 42, this shape change can be effected without changing the shape of a mold for forming the housing body 34, and therefore the productivity can be enhanced without the need for high facility costs.

In the connector structure of this construction, even when the male connector 30 advances relative to the female connector 20 in an inclined condition, a clearance is secured between the tab terminals 23 of the female connector 20 and the front holder 31 since the recesses faces 42 are formed respectively at the opposite side portions of the front end of the front holder 31. Therefore, the front holder 31 will not contact the connector housing 21 and the tab terminals 23 (see FIG. 3).

Therefore, the front holder 31, attached to the front end portion of the housing body 34, is positively prevented from contacting the connector housing 21 of the female connector 20 and the tab terminals 23, thereby positively preventing damage and deformation thereof.

As described above, in the connector structures of the first and second embodiments, the tapered faces 32 or the recessed faces 42 are formed respectively at the opposite side portions of the front end of the front holder 31 attached to the housing body 34, and therefore these tapered faces or these recessed faces provide air escape spaces respectively at the opposite side ends of the end plate portion 38 at the time of fitting of the male connector 30 into the female connector 20, and also they function to prevent a gouging engagement at the time of fitting of the front end of the housing body 34 (projecting from the fitting detection member 33) into the female connector 20.

Even when the male connector 30 advances relative to the female connector 20 in an inclined condition, the front holder 31 will not interfere with the connector housing 21 and the tab terminals 23, and damage to the connector housing 21 and the deformation of the tab terminals 23 are positively prevented.

In the connector structures of the first and second embodiments, although the slidable fitting detection member 33 is fitted on the housing body 34 of the male connector 30 in such a manner that the housing body 34 projects forwardly from this fitting detection member 33, the tapered faces 32 or the recessed faces 42 are formed at the opposite side portions of the front end of the front holder 31, respectively, and therefore the front end of the housing body 34 will not be brought into gouging engagement with the connector housing 21.

Therefore, the front holder 31 will not interfere with the connector housing 21 and the tab terminals 23, and damage to the connector housing 21 and the deformation of the tab terminals 23 are positively prevented.

In the connector structures of the first and second embodiments, the tapered faces 32 or the recessed faces 42 are formed on the front holder 31 which is separate from the housing body 34, and therefore the tapered faces 32 or the recessed faces 42 can be changed only by changing the mold for forming the front holder 31, and therefore the productivity can be enhanced without the need for high facility costs.

The connector structures of the present invention are not limited to the above embodiments, and suitable modifications and improvements can be made. For example, the size and inclination angle of the tapered faces or the recessed faces can be suitably selected, depending on the outer shapes of the two connectors.

The tapered faces or the recessed faces do not always need to be formed respectively at the horizontally-spaced opposite side portions of the front end of the housing body or the front holder, but can be formed respectively at the vertically-spaced opposite side portions of the front end thereof, or such a tapered face or such a recessed face may be formed at the end edge portion over the entire periphery thereof.

What is claimed is:

1. A connector structure, comprising:
a connector, having a tab terminal; and
a housing body, having a tab receiving terminal for electrical connecting to the tab terminal, the housing body is to be fitted with the connector,
wherein either a tapered face or a recessed face for preventing interference is formed at a side portion of a front end of the housing body.

2. The connector structure as set forth in claim 1, either the tapered face or the recessed face is formed so as to escape an air between the connector and the housing body when the connector is fitted into the housing body.

3. The connector structure as set forth in claim 1, further comprising the connector hood, covering the housing body, and being movable relative to the housing body,
wherein the front end of the housing body is projected forwardly from the connector hood in a non fitted condition between the connector and the housing body; and
wherein the connector hood slides forwardly on both the connector and the housing body in a completely-fitted condition between the connector and the housing body.

4. A connector structure, comprising;
a connector, having a tab terminal;
a housing body, having a tab receiving terminal for electrical connecting to the tab terminal, the housing body is to be fitted with the connector; and
a front holder, attached to a front end of the housing body,
wherein either a tapered face or a recessed face for preventing interference is formed at a side portion of a front end of the front holder.
